(19) United States
(12) Patent Application Publication
(10) Pub. No.: US 2023/0305500 A1
(43) Pub. Date: Sep. 28, 2023

(54) DISPLAY DEVICE AND WATCH

(71) Applicant: Japan Display Inc., Tokyo (JP)

(72) Inventors: Kaoru ITO, Tokyo (JP); Akihiko FUJISAWA, Tokyo (JP); Daichi ABE, Tokyo (JP)

(21) Appl. No.: 18/124,117

(22) Filed: Mar. 21, 2023

(30) Foreign Application Priority Data
Mar. 24, 2022 (JP) 2022-048562

(51) Int. Cl. G04G 21/08; G06F 3/041; G06F 3/044

(52) U.S. Cl. CPC G04G 21/08; G06F 3/04164; G06F 3/041662; G06F 3/0443; G06F 3/0412

(57) ABSTRACT

According to one embodiment, a display device includes a display area, a peripheral area and a plurality of detection electrodes. The display area includes a display element. The peripheral area surrounds the display area. The plurality of detection electrodes are arranged in the peripheral area. The plurality of detection electrodes are each electrically connected to at least one other detection electrode that is not adjacent thereto.

### CROSS-REFERENCE TO RELATED APPLICATIONS

This application is based upon and claims the benefit of priority from Japanese Patent Application No. 2022-048562, filed Mar. 24, 2022, the entire contents of which are incorporated herein by reference.

### FIELD

Embodiments described herein relate generally to a display device and a watch.

### BACKGROUND

In recent years, wearable devices (e.g., wristwatch-type wearable devices, spectacle-type wearable devices, etc.) have gradually become popular as one type of display device with a touch detection function. Such wearable devices are required to achieve both display quality when displaying images and excellent touch operability, and various developments are underway. For example, a wearable device with a configuration in which a plurality of touch sensors are arranged around a display area that displays images has been developed.

However, in such wearable devices, the number of analog front-end circuits connected to touch sensors may be limited due to design reasons, and the number of analog front-end circuits may become less than the number of touch sensors. In this case, the touch sensors need to be time-divisionally driven, which takes time to detect the touch.

### BRIEF DESCRIPTION OF THE DRAWINGS

FIG. 1 is a plan view of a configuration example of a display device according to an embodiment.

FIG. 2 is a plan view of another configuration example of the display device according to the same embodiment.

FIG. 3 is a plan view of yet another configuration example of the display device according to the same embodiment.

FIG. 4 is a plan view of yet another configuration example of the display device according to the same embodiment.

FIG. 5 is a cross-sectional view of a configuration example of the display device according to the same embodiment.

FIG. 6 is a cross-sectional view of another configuration example of the display device according to the same embodiment.

FIG. 7 illustrates information used to identify a position of an external proximity object that is in proximity or contact with a detection electrode in the display device according to the same embodiment.

FIG. 8 illustrates a touch detection operation in the display device according to the same embodiment.

FIG. 9 is a plan view of a configuration of a display device according to a comparative example.

FIG. 10 illustrates a touch detection operation in the display device according to the comparative example.

FIG. 11 shows an application example of a display device according to an embodiment.

FIG. 12 shows another application example of a display device according to an embodiment.

FIG. 13 shows yet another application example of a display device according to an embodiment.

FIG. 14 illustrates an example of a principle of touch detection by a self-capacitance method.

### DETAILED DESCRIPTION

In general, according to one embodiment, a display device includes a display area, a peripheral area and a plurality of detection electrodes. The display area includes a display element. The peripheral area surrounds the display area. The plurality of detection electrodes are arranged in the peripheral area. The plurality of detection electrodes are each electrically connected to at least one other detection electrode that is not adjacent thereto.

Embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

In the present embodiment, a display device with a touch detection function is described as an example of a display device. Touch detection methods include various methods such as an optical method, a resistance method, an electrostatic capacitance method, an electromagnetic induction method, and the like. Among the various detection methods mentioned above, the electrostatic capacitance method is a detection method that uses changes in electrostatic capacitance caused by proximity or contact of an object (e.g., finger), and has advantages such as being realized with a relatively simple structure and having low power consumption. In the present embodiment, a display device with a touch detection function that uses the electrostatic capacitance method is mainly described.

Note that the electrostatic capacitance method includes a mutual capacitance method and a self-capacitance method. The mutual capacitance method is a method in which an electric field is generated between a pair of transmitting electrodes (drive electrodes) and receiving electrodes (detection electrodes) arranged at a distance from each other, and changes in the electric field caused by proximity or contact of an object is detected. The self-capacitance method is a method in which changes in electrostatic capacitance caused by proximity or contact of an object is detected using a single electrode.

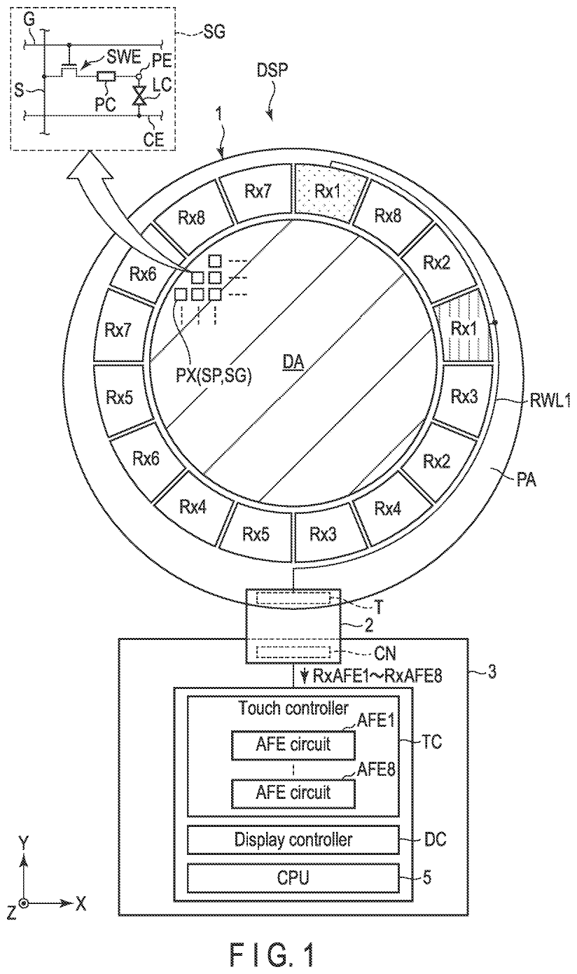

FIG. 1 is a plan view showing a configuration example of a display device DSP according to this embodiment. For example, a first direction X, a second direction Y, and a third direction Z are orthogonal to each other, but they may intersect at an angle other than 90°. The first direction X and the second direction Y correspond to the directions parallel to a main surface of a substrate that constitutes the display device DSP. The third direction Z corresponds to a thickness direction of the display device DSP. In the following descriptions, the third direction Z is referred to as “upward” and a direction opposite to the third direction is referred to as “downward”. With such expressions “a second member above a first member” and “a second member below a first member”, the second member may be in contact with the first member or may be remote from the first member. In addition, it is assumed that there is an observation position to observe the display device DSP on a tip side of an arrow in a third direction Z, and viewing from this observation position toward the X-Y plane defined by the first direction X and the second direction Y is referred to as plan view.

As shown in FIG. 1, the display device DSP has a display panel 1, a flexible printed circuit board 2, and a circuit board 3. The display panel 1 and the circuit board 3 are electrically connected via the flexible printed circuit board 2. More specifically, a terminal portion T of the display panel 1 and a connection portion CN of the circuit board 3 are electrically connected via the flexible printed circuit board 2. The circuit board 3 is provided with a touch controller TC, a display controller DC, a CPU 5, and the like. FIG. 1 illustrates a case in which the touch controller TC, the display controller DC, and the CPU 5 are realized by a single IC chip. The touch controller TC contains eight analog front-end circuits (AFE circuits) AFE1 to AFE8. In the following description, the analog front-end circuits AFE1 to AFE8 are simply referred to as analog front-end circuits AFE in the case where they are not specifically distinguished. The analog front-end circuit AFE may also be referred to as a detection circuit.

The display panel 1 comprises a display area DA for displaying images and a frame-like peripheral area PA surrounding the display area DA. The display area DA may be referred to as a display portion. The peripheral area PA may also be referred to as a peripheral portion, a frame portion, or a non-display portion. Pixels PX, which are display elements, are arranged in the display area DA. Specifically, a number of pixels PX are arranged in the display area DA in a matrix along the first direction X and the second direction Y.

In the present embodiment, the pixel PX includes red (R), green (G), and blue (B) sub-pixels SP. Each sub-pixel SP has a plurality of segment pixels SG. Each segment pixel SG has a pixel electrode with a different area, and by switching display/non-display of these multiple segment pixels SG, a gradation is formed for each sub-pixel SP.

As shown enlarged in FIG. 1, the segment pixel SG comprises a switching element SWE, a pixel circuit PC, a pixel electrode PE, a common electrode CE, a liquid crystal layer LC, etc.

The switching element SWE is configured by a thin-film transistor (TFT), for example, and is electrically connected to a scanning line G and a signal line S. The scanning line G is electrically connected to the switching element SWE in each of the segment pixels SG aligned in the first direction X. The signal line S is electrically connected to the switching element SWE in each of the segment pixels SG aligned in the second direction Y.

The pixel electrode PE is electrically connected to the switching element SWE via the pixel circuit PC. Each of the pixel electrodes PE faces the common electrode CE and drives the liquid crystal layer LC by an electric field generated between the pixel electrode PE and the common electrode CE. Note that, in the present embodiment, a configuration in which the pixel electrode PE is electrically connected to the switching element SWE via the pixel circuit PC is illustrated. However, the pixel electrode PE may be electrically connected to the switching element SWE without via the pixel circuit PC.

Among a plurality of concentric circles shown in FIG. 1, an area of the innermost circle corresponds to the display area DA, and an area between the innermost circle and an outermost circle corresponds to the peripheral area PA. In other words, a shaded area in FIG. 1 corresponds to the display area DA, and the other areas correspond to the peripheral area PA.

Note that, in the present embodiment, a case in which the display area DA is circular and the peripheral area PA surrounding the display area DA is also of the same type of shape is shown as an example; however, it is not limited thereto, and the display area DA does not have to be circular and the peripheral area PA may be of a different type of shape from the display area DA. For example, the display area DA and the peripheral area PA may be polygonal in shape. Furthermore, in the case where the display area DA has a polygonal shape, the peripheral area PA may have a circular shape, which is a shape of a system different from that of the display area DA.

As shown in FIG. 1, in the peripheral area PA, a total of 16 detection electrodes Rx1 to Rx8, which are two detection electrodes Rx1 electrically connected to each other, two detection electrodes Rx2 electrically connected to each other, two detection electrodes Rx3 electrically connected to each other, two detection electrodes Rx4 electrically connected to each other, two detection electrodes Rx5 electrically connected to each other, two detection electrodes Rx6 electrically connected to each other, two detection electrodes Rx7 electrically connected to each other, and two detection electrodes Rx8 electrically connected to each other are arranged in a manner surrounding the display area DA. In the following description, detection electrodes Rx1 to Rx8 will be referred to simply as detection electrodes Rx in the case where they are not specifically distinguished.

The size of each detection electrode Rx is less than 9 mm, which is an average size of a finger. Therefore, in a case where the peripheral area PA is touched by a user, two or more detection electrodes Rx are in contact with the user's finger.

As described below in detail, the two detection electrodes Rx electrically connected to each other are arranged so that they are not adjacent to each other. Another way to describe it is that the two detection electrodes Rx electrically connected to each other are arranged at least 9 mm apart, which is the average size of a finger.

The two detection electrodes Rx1 are connected to the terminal portion T arranged in the peripheral area PA via an Rx wiring line RWL1.

Furthermore, the two detection electrodes Rx1 are connected to the same terminal of the IC chip including the touch controller TC, the display controller DC, and the CPU 5 via the terminal portion T and the connection portion CN. More specifically, the two detection electrodes Rx1 are connected to one analog front-end circuit AFE1 included in the touch controller TC via the terminal portion T and the connection portion CN. Therefore, a detection signal RxAFE1 output from the two detection electrodes Rx1 is input to one analog front-end circuit AFE1.

In FIG. 1, illustrations of Rx wiring lines other than the Rx wiring line RWL1 corresponding to the two detection electrodes Rx1 are omitted in order to avoid complication of the drawing; however, a detection signal RxAFE2 output from the two detection electrodes Rx2 is input to one analog front-end circuit AFE2 through a corresponding Rx wiring line. In the same manner, detection signals RxAFE3 to RxAFE8 output from the other two respective detection electrodes Rx3 to Rx8 are input to corresponding analog front-end circuits AFE3 to AFE8 through corresponding Rx wiring lines, respectively.

As described in detail below, the touch controller TC performs touch detection based on the detection signals RxAFE1 to RxAFE8 that are input to the analog front-end circuits AFE1 to AFE8.

The 16 detection electrodes Rx are arranged so that the combination of analog front-end circuits AFE connected to each of the two adjacent detection electrodes Rx is different for all of the two adjacent detection electrodes Rx.

For example, the detection electrode Rx1, dotted in FIG. 1, is arranged adjacent to the detection electrode Rx7 which is connected to the analog front-end circuit AFE7, and the detection electrode Rx8 which is connected to the analog front-end circuit AFE8. Of the 16 detection electrodes Rx, the detection electrode Rx1 connected to the analog front-end circuit AFE1 and the detection electrode Rx7 connected to the analog front-end circuit AFE7 are arranged adjacent to each other only at this position. Of the 16 detection electrodes Rx, the detection electrode Rx1 connected to the analog front-end circuit AFE1 and the detection electrode Rx8 connected to the analog front-end circuit AFE8 are arranged adjacent to each other only at this position. Similarly, the detection electrode Rx1, marked with a vertical line in FIG. 1, is arranged adjacent to the detection electrodes Rx2 and Rx3. Of the 16 detection electrodes Rx, the detection electrode Rx1 connected to the analog front-end circuit AFE1 and detection electrode Rx2 connected to the analog front-end circuit AFE2 are arranged adjacent to each other only at this position. Also, of the 16 detection electrodes Rx, the detection electrode Rx1 connected to the analog front-end circuit AFE1 and the detection electrode Rx3 connected to the analog front-end circuit AFE3 are arranged adjacent to each other only at this position.

Here, as an example, two detection electrodes Rx1 have been focused. However, the other detection electrodes Rx2 to Rx8 are also similarly arranged so that the combination of themselves and the detection electrodes arranged adjacent to themselves is arranged only at the relevant positions.

In FIG. 1, 16 detection electrodes Rx1 to Rx8 are illustrated, but the number of detection electrodes Rx to be arranged in the peripheral area PA is not limited to this, and any number of detection electrodes Rx may be arranged to surround the display area DA. However, the number of detection electrodes Rx should be at least twice the number of analog front-end circuits AFE. As mentioned above, the size of each detection electrode Rx shall be less than 9 mm, and two detection electrodes Rx electrically connected to each other shall be arranged at least 9 mm apart. In addition, at least two different detection electrodes are arranged between two detection electrodes Rx connected to the same analog front-end circuit AFE.

Furthermore, FIG. 1 illustrates a case in which each of the 16 detection electrodes Rx1 to Rx8 is a circular arc shape (arch shape). However, the shape of the detection electrodes Rx is not limited thereto, and the detection electrodes Rx may be polygonal or any other shape.

The display controller DC outputs a video signal indicating an image to be displayed in the display area DA. The CPU 5 outputs synchronization signals that define operation timings of the touch controller TC and the display controller DC, executes operations according to touches detected by the touch controller TC, and the like.

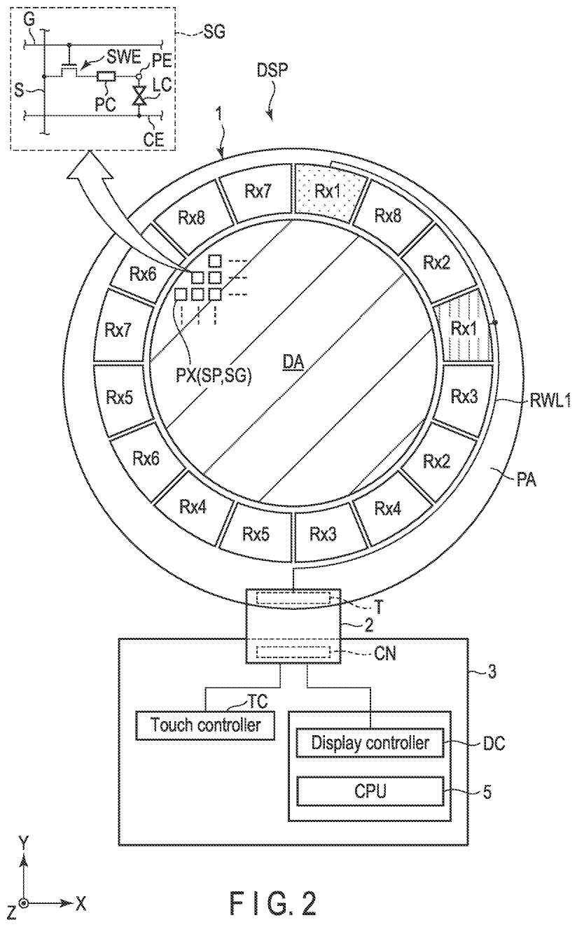

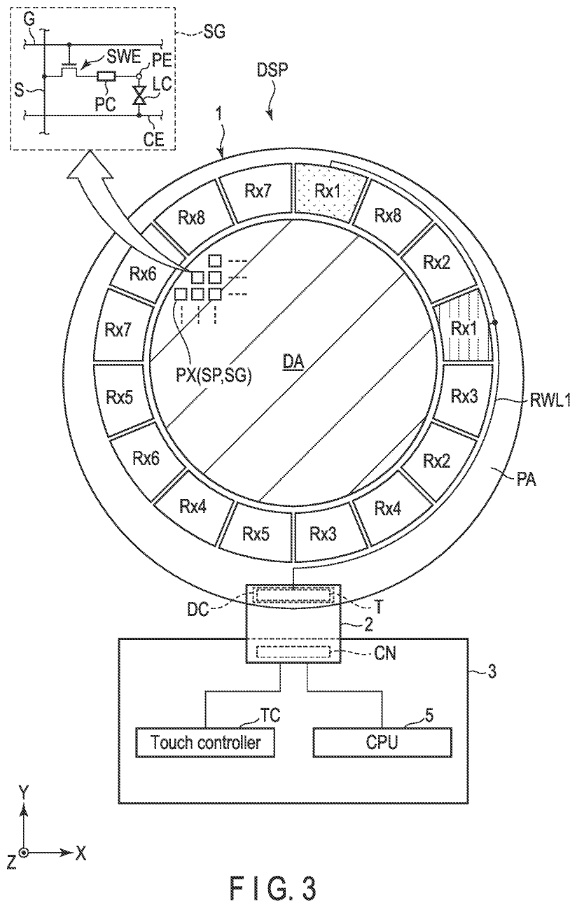

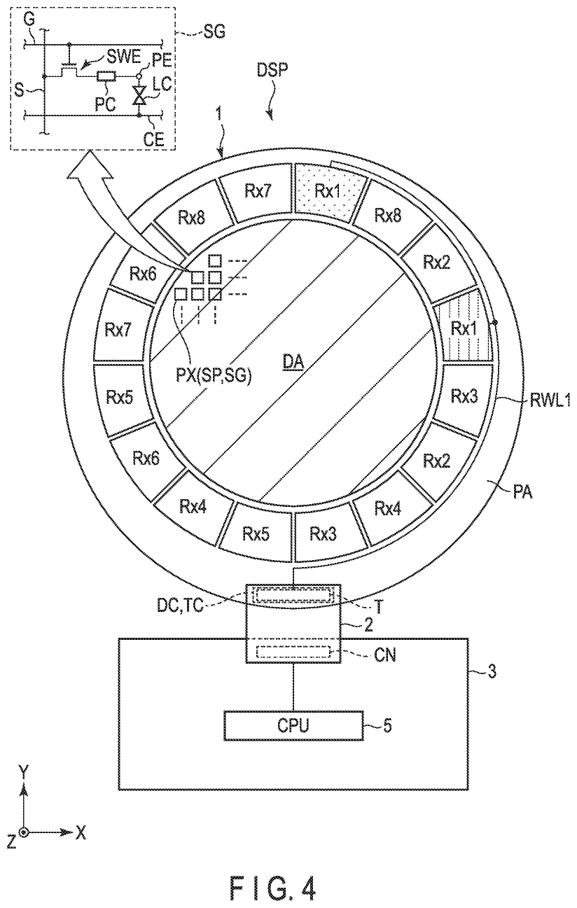

Note that, as mentioned above, FIG. 1 illustrates the case in which the touch controller TC, the display controller DC, and the CPU 5 are realized on a single IC chip; however, the implementation is not limited thereto. For example, as shown in FIG. 2, it is possible to separate only the touch controller TC as a separate body and mount each part on the circuit board 3. As shown in FIG. 3, it is possible to mount the touch controller TC and the CPU 5 separately on the circuit board 3 and mount the display controller DC on the display panel 1 using COG (Chip on Glass). As shown in FIG. 4, it is possible to mount only the CPU5 on the circuit board 3 and mount the touch controller TC and the display controller DC on the display panel 1 using COG.

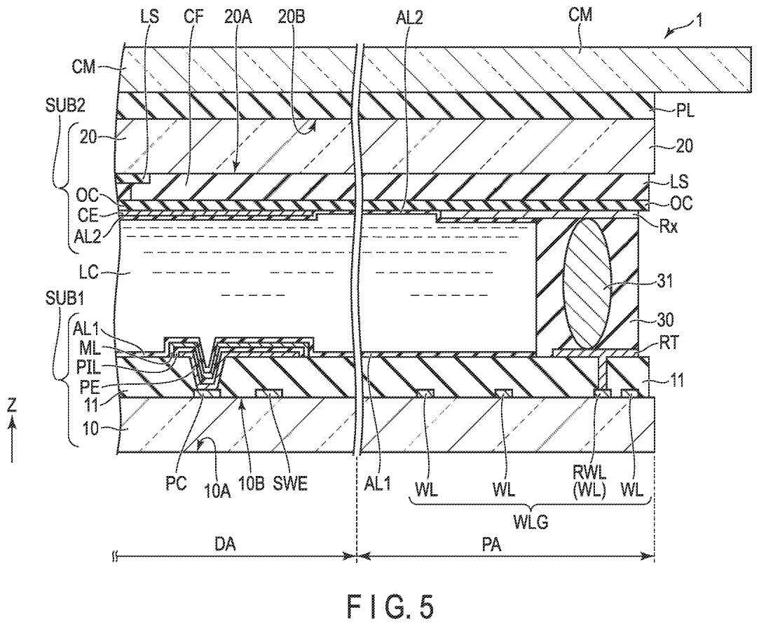

FIG. 5 is a cross-sectional view of a configuration example of the display panel 1. In the following, a configuration on the display area DA side and a configuration on the peripheral area PA side will be described respectively.

The display panel 1 comprises a first substrate SUB1, a second substrate SUB2, a sealant 30, a liquid crystal layer LC, a polarizing plate PL, and a cover member CM. The first substrate SUB1 may be referred to as an array substrate, and the second substrate SUB2 may be referred to as a facing substrate. The first substrate SUB1 and the second substrate SUB2 are formed in a plate shape parallel to the X-Y plane.

The first substrate SUB1 and the second substrate SUB2 are superposed in planar view and are bonded (connected) by the sealant 30. The liquid crystal layer LC is held between the first substrate SUB1 and the second substrate SUB2 and sealed by the sealant 30. The sealant 30 contains a number of conductive pearls 31 coated with metal. The configuration on the first substrate SUB1 side and the configuration on the second substrate SUB2 side are electrically connected via the conductive pearls 31.

The polarizing plate PL is provided on the second substrate SUB2, and the cover member CM is further provided on the polarizing plate PL.

Note that, in FIG. 5, a case in which the display panel 1 is a reflective type display panel in which no backlight unit is arranged is illustrated. However, the display panel 1 is not limited thereto, and may be a display panel employing an organic EL as pixels or a transmissive type display panel in which a backlight unit is arranged. Alternatively, the display panel 1 may be a display panel combining reflective and transmissive types. As a backlight unit, various forms of backlight units can be used, such as one using a light-emitting diode (LED) as a light source, and one using a cold cathode fluorescent lamp (CCFL). Note that, in a case where the backlight unit is arranged, a polarizing plate is arranged between the first substrate SUB1 and the backlight unit (i.e., under the first substrate SUB1).

On the display area DA side, the first substrate SUB1 comprises a transparent substrate 10, a switching element SWE, a pixel circuit PC, a planarization film 11, a pixel electrode PE, an interlayer insulating film PIL, a metal film ML, and an alignment film AL1, as shown in FIG. 5. In addition to the above configuration, the first substrate SUB1 comprises the scanning line G, the signal line S, etc., shown in FIG. 1, but illustrations thereof are omitted in FIG. 5.

The transparent substrate 10 comprises a main surface (bottom surface) 10A and a main surface (top surface) 10B on the opposite side of the main surface 10A. The switching element SWE and the pixel circuit PC are arranged on the main surface 10B side. The planarization film 11 is configured by at least one or more insulating films and covers the switching element SWE and the pixel circuit PC.

The pixel electrode PE is arranged on the planarization film 11 and is connected to the pixel circuit PC through a contact hole formed in the planarization film 11. The switching element SWE, the pixel circuit PC, and the pixel electrode PE are arranged for each segment pixel SG. The pixel electrode PE is covered by the interlayer insulating film PIL. The metal film ML is provided on the interlayer insulating film PIL. The alignment film AL1 covers the planarization film 11 and the metal film ML and is in contact with the liquid crystal layer LC.

Note that, in FIG. 5, the switching element SWE and the pixel circuit PC are illustrated in a simplified manner; however, the switching element SWE and the pixel circuit PC actually include semiconductor layers and electrodes in each layer. In addition, although the drawing is omitted in FIG. 5, the switching element SWE and the pixel circuit PC are electrically connected. Furthermore, as described above, the scanning line G and the signal line S omitted in FIG. 5 are arranged between the transparent substrate 10 and the planarization film 11, for example.

On the display area DA side, as shown in FIG. 5, the second substrate SUB2 comprises a transparent substrate 20, a light shielding film LS, a color filter CF, an overcoat layer OC, a common electrode CE, and an alignment film AL2.

The transparent substrate 20 comprises a main surface (bottom surface) 20A and a main surface (top surface) 20B on the opposite side of the main surface 20A. The main surface 20A of the transparent substrate 20 faces the main surface 10B of the transparent substrate 10. The light-shielding film LS partitions each segment pixel SG. The color filter CF is arranged on the main surface 20A side of the transparent substrate 20, faces the pixel electrode PE, and partially overlaps the light-shielding film LS. The color filter CF includes a red color filter, a green color filter, a blue color filter, etc. The overcoat layer OC covers the color filter CF.

The common electrode CE is arranged over the plurality of segment pixels SG (plurality of pixels PX) and faces the plurality of pixel electrodes PE in the third direction Z. The common electrode CE is arranged under the overcoat layer OC. The alignment film AL2 covers the overcoat layer OC and the common electrode CE and is in contact with the liquid crystal layer LC.

The liquid crystal layer LC is arranged between the main surface 10B and the main surface 20A.

The transparent substrates 10 and 20 are insulating substrates, such as glass substrates or plastic substrates. The planarization film 11 is formed by a transparent insulating material such as silicon oxide, silicon nitride, silicon oxynitride or acrylic resin. In one example, the planarization film 11 includes an inorganic insulating film and an organic insulating film.

The pixel electrode PE is a transparent electrode formed by a transparent conductive material such as indium tin oxide (ITO) or indium zinc oxide (IZO). The metal film ML is formed of silver (Ag), for example. Note that, instead of providing the metal film ML on the pixel electrode PE, the pixel electrode PE itself may be formed as a reflective electrode. In this case, the pixel electrode PE is formed, for example, with a three-layer stacked structure of indium zinc oxide (IZO), silver (Ag), and indium zinc oxide (IZO). The common electrode CE is a transparent electrode formed by a transparent conductive material such as indium tin oxide (ITO) or indium zinc oxide (IZO).

The alignment films AL1 and AL2 are horizontal alignment films having an alignment regulating force approximately parallel to the X-Y plane. The alignment regulating force may be imparted by a rubbing process or by a photo-alignment process.

On the peripheral area PA side, as shown in FIG. 5, the first substrate SUB1 comprises the transparent substrate 10, a wiring line group WLG including a plurality of wiring lines WL, the planarization film 11, an Rx terminal portion RT, and the alignment film AL1. In the following, a detailed description of the configuration already described on the display area DA side will be omitted.

On the main surface 10B side of the transparent substrate 10, the wiring line group WLG including the plurality of wiring lines WL is arranged. The plurality of wiring lines WL included in the wiring line group WLG are covered by the planarization film 11. Note that, in FIG. 5, four wiring lines WL including an Rx wiring line RWL are illustrated as the plurality of wiring lines WL included in the wiring line group WLG; however, the number of plurality of wiring lines WL included in the wiring line group WLG is not limited thereto. The plurality of wiring lines WL included in the wiring line group WLG may further include signal lines S, wiring lines for supplying power to the common electrode CE, etc.

The Rx terminal portion RT is provided on the planarization film 11. The Rx terminal portion RT is provided in a position overlapped on the sealant 30 in planar view. The Rx terminal portion RT is connected to the Rx wiring line RWL, which is one of the wiring lines included in the wiring line group WLG, through a contact hole formed in the planarization film 11. The Rx terminal portion RT is electrically connected to the detection electrode Rx provided on the second substrate SUB2 side by the conductive pearl 31 included in the sealant 30.

The alignment film AL1 covers the planarization film 11 and contacts the liquid crystal layer LC in the area where the liquid crystal layer LC is arranged in the peripheral area PA.

On the peripheral area PA side, as shown in FIG. 5, the second substrate SUB2 comprises the transparent substrate 20, the light shielding film LS, the overcoat layer OC, the detection electrode Rx, and the alignment film AL2. In the following, a detailed description of the configuration already described on the display area DA side will be omitted.

On the main surface 20A side of the transparent substrate 20, the light-shielding film LS is arranged. The light shielding film LS is arranged over almost the entire surface of the peripheral area PA. The overcoat layer OC covers the light-shielding film LS together with the color filter CF on the display area DA side.

As shown in FIG. 5, the detection electrode Rx is arranged under the overcoat layer OC. The detection electrode Rx is arranged on the same layer as the common electrode CE on the display area DA side and is formed, for example, by the same transparent conductive material as the common electrode CE. The detection electrode Rx extends from an area where the sealant 30 is not arranged in the peripheral area PA (an area where the liquid crystal layer LC is arranged in the peripheral area PA) to an area where the sealant 30 is arranged. The detection electrode Rx is electrically connected to the Rx terminal portion RT and the Rx wiring line RWL arranged on the first substrate SUB1 side by the conductive pearl 31 contained in the sealant 30.

The alignment film AL2 covers the overcoat layer OC and the detection electrode Rx in the area where the liquid crystal layer LC is arranged in the peripheral area PA, and is in contact with the liquid crystal layer LC.

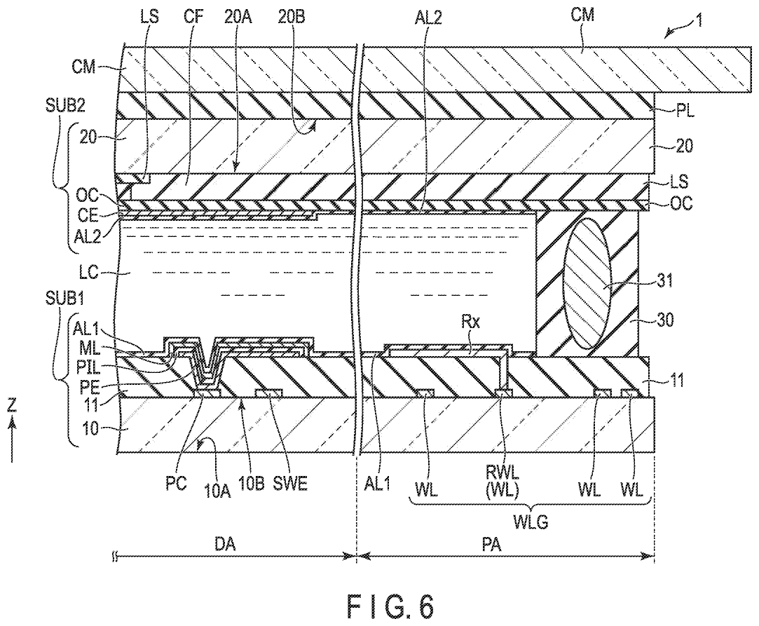

Note that, in FIG. 5, a configuration in which the detection electrode Rx is arranged on the second substrate SUB2 side is illustrated; however, as shown in FIG. 6, the detection electrode Rx may be arranged on the first substrate SUB1 side. Note that, in FIG. 6, the conductive pearl 31 is in a floating state; however, the conductive pearl 31 is uniformly arranged in the sealant 30. For example, in an area where the common electrode CE extends to the sealant 30, the common electrode CE is electrically connected by the conductive pearl 31 to a feed line arranged on the first substrate SUB1 side.

The liquid crystal modes are classified into two modes according to a direction of application of the electric field for changing alignment of liquid crystal molecules included in the liquid crystal layer LC. In FIG. 5, a configuration in a case where a liquid crystal mode is a so-called vertical electric field mode is shown. However, this configuration is also applicable to a case where the liquid crystal mode is a so-called horizontal electric field mode. The vertical electric field mode described above includes, for example, a twisted nematic (TN) mode and a vertical alignment (VA) mode. In addition, the horizontal electric field mode includes, for example, an in-plane switching (IPS) mode and a fringe field switching (FFS) mode, which is one of the IPS modes.

In the case of adopting the horizontal electric field mode, the common electrode CE provided in the display area DA is provided on the first substrate SUB1 side and faces the pixel electrode PE through a thin insulating layer. The detection electrode Rx is also provided on the first substrate SUB1 side similarly to the common electrode CE.

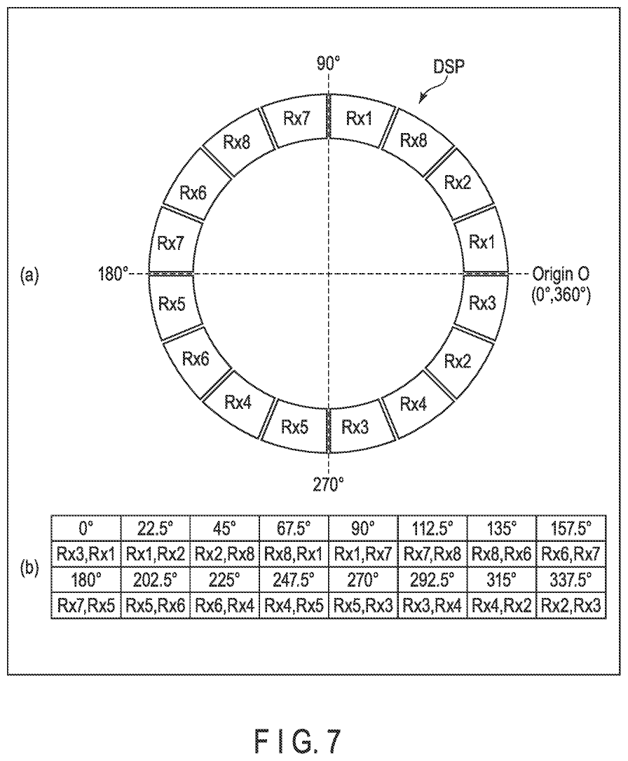

FIG. 7 illustrates information used to identify the position of an external proximity object that is in proximity or contact with the detection electrode Rx in the display device DSP. In the following, the outline will be first described with reference to FIG. 7(a) followed by a more detailed description with reference to FIG. 7(b).

As shown in FIG. 7(a), in the display device DSP according to the present embodiment, a position between the two adjacent detection electrodes Rx3 and Rx1 corresponds to an origin O and a 0° (360°) angle position. In the display device DSP according to the present embodiment, as shown in FIG. 7(a), a position between the two adjacent detection electrodes Rx1 and Rx7 (i.e., a position rotated 90° counterclockwise from the origin O) corresponds to a 90° angle position. In the display device DSP according to the present embodiment, as shown in FIG. 7(a), a position between the two adjacent detection electrodes Rx7 and Rx5 (i.e., a position rotated 180° counterclockwise from the origin O) corresponds to a 180° angle position. In the display device DSP according to the present embodiment, as shown in FIG. 7(a), a position between the two adjacent detection electrodes Rx5 and Rx3 (i.e., a position rotated 270° counterclockwise from the origin O) corresponds to a 270° angle position. As described above, a position between two adjacent detection electrodes Rx can be expressed by using the angle rotated counterclockwise from the origin O.

FIG. 7(b) is a position identification table in which the two adjacent detection electrodes and the angle corresponding to the position between the two adjacent detection electrodes are mapped. As also described in FIG. 7(a), the position between the two adjacent detection electrodes Rx3 and Rx1 corresponds to the 0° angle position (origin O). As shown in

FIG. 7(b), the position between the two adjacent detection electrodes Rx1 and Rx2 corresponds to a 22.5° angle position. Furthermore, as shown in FIG. 7(b), the position between the two adjacent detection electrodes Rx2 and Rx8 corresponds to a 45° angle position. As shown in FIG. 7(b), the position between the two adjacent detection electrodes Rx8 and Rx1 corresponds to a 67.5° angle position. Furthermore, as shown in FIG. 7(b), the position between the two adjacent detection electrodes Rx1 and Rx7 corresponds to the 90° angle position.

Since other combinations of two adjacent detection electrodes Rx can be described in the same manner, the detailed description thereof is omitted here. However, as shown in FIG. 7(b), positions between two adjacent detection electrodes Rx can be expressed by an angle rotated respectively by 22.5° in the counterclockwise direction from the position between electrodes Rx3 and Rx1 (origin O).

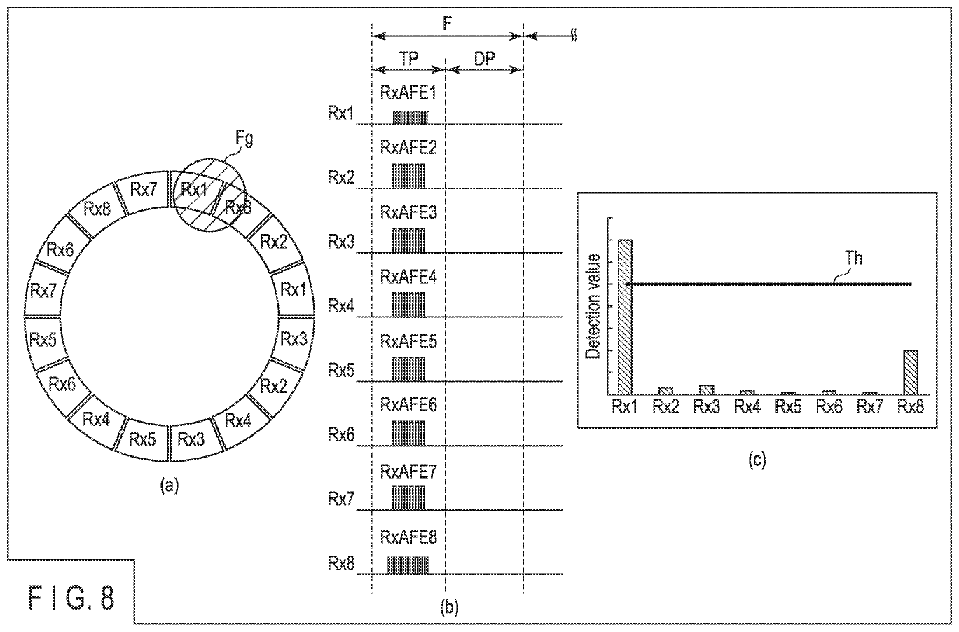

FIG. 8 illustrates a touch detection operation in the display device DSP. Here, as shown in FIG. 8(a), a case in which a finger Fg is in contact with the detection electrodes Rx1 and Rx8 is assumed.

Also, as shown in FIG. 8(a), here, a case in which an area where the finger Fg is in contact with the detection electrode Rx1 is larger than an area where the finger Fg is in contact with the detection electrode Rx8 (i.e., the finger Fg is closer to the detection electrode Rx1 side) is assumed.

One frame period F includes a touch period TP for detecting the contact of the finger Fg in a self-capacitance method and a display period DP for displaying an image as shown in FIG. 8(b), for example. When the touch period TP starts, the touch controller TC accepts the input of detection signals RxAFE1 to RxAFE8 output from the detection electrodes Rx1 to Rx8 via the analog front-end circuits AFE1 to AFE8. The touch controller TC identifies the position where the finger Fg is in contact based on the detection signals accepted for input.

Here, as shown in FIG. 8(a), a case in which the finger Fg is in contact with the detection electrodes Rx1 and Rx8 and the contact area between the finger Fg and the detection electrode Rx1 is larger than that between the finger Fg and the detection electrode Rx8 is assumed. Therefore, as shown in FIG. 8(b), the amplitude of the waveform of the detection signal RxAFE1 output from the detection electrode Rx1 becomes smaller than that of detection signals RxAFE2 to RxAFE8 output from other detection electrodes Rx2 to Rx8. In addition, as shown in FIG. 8(b), the amplitude of the waveform of the detection signal RxAFE8 output from the detection electrode Rx8 becomes larger than that of the waveform of the detection signal RxAFE1 described above, and the amplitude becomes smaller than that of the waveforms of the detection signals RxAFE2 to RxAFE7 output from other detection electrodes Rx2 to Rx7 with which the finger Fg is not in contact. Note that the waveforms of the detection signals RxAFE2 to RxAFE7 output from other detection electrodes Rx2 to Rx7, with which the finger Fg is not in contact, have about the same amplitude as each other, as shown in FIG. 8(b).

According to the perspective of a detection value of the detection signal RxAFE, the detection value of the detection signal RxAFE1 output from the detection electrode Rx1 is larger than that of detection signals RxAFE2 to RxAFE8 output from other detection electrodes Rx2 to Rx8 as shown in FIG. 8(c). Note that the detection value of the detection signal RxAFE is an output value of the analog front-end circuit AFE to which the detection signal RxAFE is input, and the detection value of the detection signal RxAFE becomes larger as the amplitude of the waveform shown in FIG. 8(b) becomes smaller.

As shown in FIG. 8(c), the detection value of the detection signal RxAFE8 output from the detection electrode Rx8 is smaller than the detection value of the detection signal RxAFE1 described above, and the detection value becomes larger than the detection values of the detection signals RxAFE2 to RxAFE7 output from other detection electrodes Rx2 to Rx7 with which the finger Fg is not in contact. Note that the detection values of the detection signals RxAFE2 to RxAFE7 output from other detection electrodes Rx2 to Rx7 with which the finger Fg is not in contact become about the same value as each other as shown in FIG. 8(c).

The touch controller TC identifies the position of the contacting finger Fg based on the detection values of the detection signals RxAFE described above. In more detail, the touch controller TC first identifies the position where the finger Fg is at least in contact based on (1) the largest value of the detection values of the detection signals RxAFE1 to RxAFE8, (2) the second largest value of the detection values of the detection signals RxAFE1 to RxAFE8 and (3) the position identification table shown in FIG. 7(b). Here, as shown in FIG. 8(c), the detection value of the detection signal RxAFE1 is the largest value exceeding a threshold value Th and the detection value of the detection signal RxAFE8 is the second largest. Therefore, the touch controller TC identifies that the finger Fg is in contact at a 67.5° angle position corresponding to a combination of the detection electrode Rx1 from which the detection signal RxAFE1 was output and the detection electrode Rx 8 from which the detection signal RxAFE8 was output.

Once the touch controller TC identifies the position where the finger Fg is at least in contact, it identifies the detailed position of the finger Fg based on formula (1) described below.

The detailed position of the finger Fg=the position where the finger Fg is at least in contact+{(−22.5*S1)+(22.5*S2)}/(S1+S2) . . . formula (1)

S1 shown in the above formula (1) indicates the detection value of the detection signal RxAFE output from the detection electrode Rx positioned on the right side of the two adjacent detection electrodes Rx when moving in the counterclockwise direction from the origin O. S2 in the above formula (1) indicates the detection value of the detection signal RxAFE output from the detection electrode Rx positioned on the left side of the two adjacent detection electrodes Rx when moving in the counterclockwise direction from the origin O.

Here, as described above, the position where the finger Fg is at least in contact is identified to be between the detection electrodes Rx8 and Rx1 (i.e., at a 67.5° angle position). Therefore, of the two adjacent detection electrodes Rx8 and Rx1, it is identified that the detection electrode positioned on the right side is the detection electrode Rx8 when moving in the counterclockwise direction from the origin O. Also, of the two adjacent detection electrodes Rx8 and Rx1, it is identified that the detection electrode positioned on the left side is the detection electrode Rx1 when moving in the counterclockwise direction from the origin O. In other words, the detection value of the detection signal RxAFE8 output from the detection electrode Rx8 is assigned to S1 in the above formula (1), and the detection value of the detection signal RxAFE1 output from the detection electrode Rx1 is assigned to S2 in the above formula (1). As shown in FIG. 8(c), since the detection value of the detection signal RxAFE1 and the detection value of the detection signal RxAFE8 show a relationship of 3.5:1, here, the above S1 can be regarded as “1” and the above S2 as “3.5”. Based on the above, the detailed position of the finger Fg shown in FIG. 8(a) can be identified based on the above formula (1) and the various values as follows.

$$67.5 ° + \{ ( - 22.5 ° * 1 ) + ( 22.5 ° * 3.5 ) \} / ( 1 + 3.5 ) = 67.5 ° + ( 56.25 ° / 4.5 ) = 80 °$$

By executing the series of processes described above, the finger Fg shown in FIG. 8(a) is identified as being in contact at a 80° angle position. This position (the detailed position of the finger Fg) corresponds to the substantial center of the finger Fg or the center of gravity of the contact surface of the finger Fg. Note that, here, the touch controller TC is described as identifying the position where the finger Fg is at least in contact and the detailed position of the finger Fg. However, it is not limited thereto, and the CPUS may identify the position where the finger Fg is at least in contact and the detailed position of the finger Fg based on the detection values of the detection signals RxAFE output from the analog front end circuits AFE1 to AFE8 respectively.

In the following, the effects of the display device DSP according to the present embodiment will be described using a comparative example. Note that the comparative example is intended to illustrate some of the effects that the display device DSP according to the present embodiment can achieve, and does not exclude from the scope of the present invention the configurations and effects common to the present embodiment and the comparative examples.

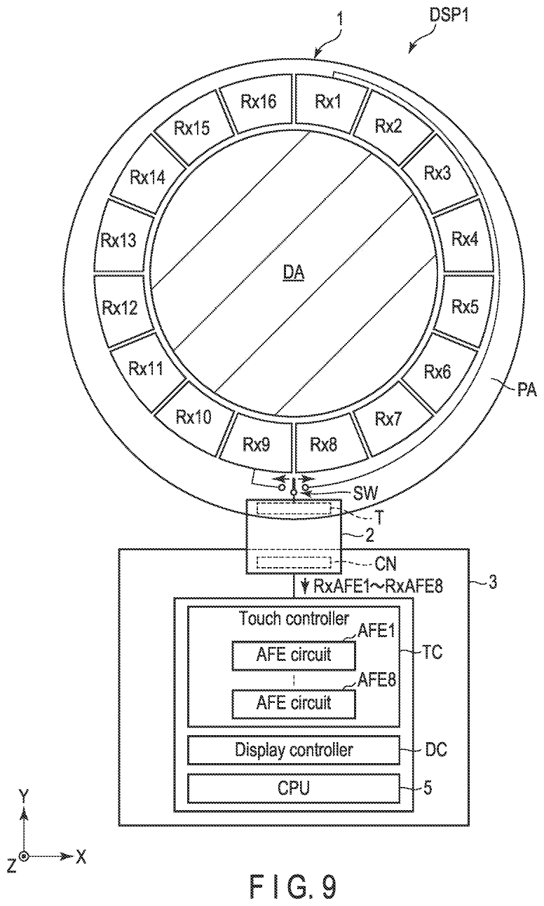

FIG. 9 is a plan view of a display device DSP1 according to the comparative example. That the display device DSP1 according to the comparative example has 16 detection electrodes Rx and eight analog front-end circuits AFE connected to these detection electrodes Rx is the same as that of the display device DSP according to the present embodiment. That is, that the number of analog front-end circuits AFE is less than the number of detection electrodes Rx, and two detection electrodes Rx are connected to one analog front-end circuit AFE, is the same as that of the display device DSP according to the present embodiment.

On the other hand, the display device DSP1 according to the comparative example has a switch SW between the detection electrode Rx and the analog front-end circuit AFE, and by switching the switch SW, one of the two detection electrodes Rx and the corresponding analog front-end circuit AFE are connected sequentially. In this respect, it differs from the display device DSP according to the present embodiment.

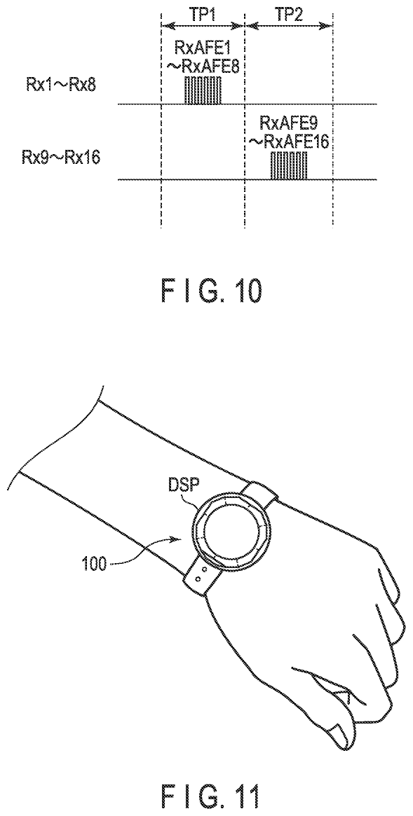

In the display device DSP1 according to the comparative example, since it is necessary to time-divisionally drive the detection electrodes Rx1 to Rx8 and the detection electrodes Rx9 to Rx16, as shown in FIG. 10, it is necessary to provide a first touch period TP1 and a second touch period TP2. The first touch period TP1 is a period in which each analog front-end circuit AFE connects with one of the corresponding two detection electrodes Rx via the switch SW and drives the one detection electrode Rx. The second touch period TP2 is a period in which the switch SW is switched to connect with the other of the two corresponding detection electrodes Rx and drive the other detection electrode Rx. This makes touch detection time consuming.

In contrast, in the display device DSP according to the present embodiment, the 16 detection electrodes Rx are arranged so that the combination of each of the analog front-end circuits AFE connected to two adjacent detection electrodes Rx is different for all of the two adjacent detection electrodes Rx. In addition, in the display device DSP according to the present embodiment, the position of the external proximity object is identified based on the largest detection value and the second largest detection value output from the analog front-end circuit AFE. Therefore, there is no need to time-divisionally drive the detection electrodes Rx, and touch detection can be performed in a shorter time compared to the display device DSP1 according to the comparative example.

In addition, since the display device DSP according to the present embodiment does not need to provide a configuration corresponding to the switch SW of the display device DSP1 according to the comparative example, it is possible to reduce the cost and, furthermore, factors that may cause physical failure. Therefore, it is possible to achieve a more reliable configuration at a lower cost than the display device DSP1 according to the comparative example.

FIG. 11 shows an application example of the display device DSP according to one embodiment. As shown in FIG. 11, the display device DSP is applied to a wristwatch 100, for example. In this case, the display area DA of the display device DSP shows the time, etc., the display device DSP detects a predetermined gesture by a touch on the detection electrode Rx arranged in the peripheral area PA (e.g., a gesture of touching the outer circumference of the watch clockwise to make one rotation, a gesture of touching the outer circumference of the watch counterclockwise to make one rotation, and a tapping gesture), and an operation in response to the detected predetermined gesture can be achieved.

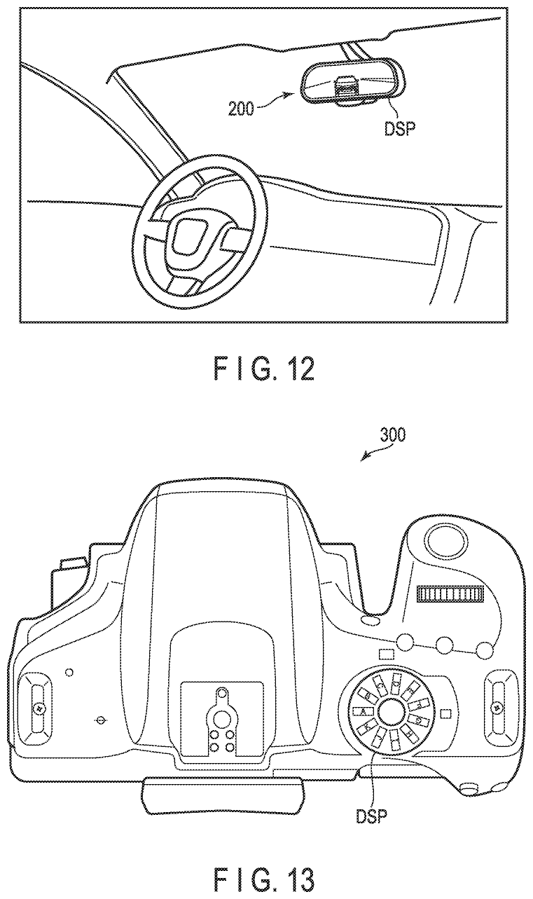

FIG. 12 shows another application example of the display device DSP according to one embodiment. As shown in FIG. 12, the display device DSP is applied, for example, to an in-vehicle rearview mirror 200. In this case, the display area DA of the display device DSP displays an image, etc., of the rear of a vehicle taken by a camera installed in the vehicle, the display device DSP detects a predetermined gesture by a touch on the detection electrode Rx arranged in the peripheral area PA, and an operation in response to the detected predetermined gesture can be achieved.

FIG. 13 shows yet another application example of the display device DSP according to one embodiment. As shown in FIG. 13, the display device DSP is applied, for example, to a camera dial 300. In this case, a plurality of icons, etc., indicating a shooting mode of a camera are displayed on the display area DA of the display device DSP, the display device DSP detects a predetermined gesture by a touch on the detection electrode Rx arranged in the peripheral area PA, and an operation in response to the detected predetermined gesture can be achieved.

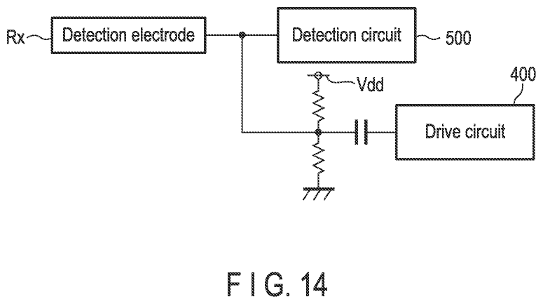

FIG. 14 illustrates an example of the principle of touch detection by a self-capacitance method. A voltage obtained by dividing a voltage of a power supply Vdd by voltage divider using resistor is supplied to the detection electrode Rx as a bias voltage. A drive signal of a predetermined waveform is supplied to a detection electrode Rx from a drive circuit 400 by capacitive coupling, etc., and a detection signal RxAFE of the predetermined waveform is read out from the detection electrode Rx. At this time, the amplitude of the detection signal RxAFE changes when a capacitance due to a finger or the like is loaded on the detection electrode Rx. For example, the amplitude of the detection signal RxAFE decreases. Therefore, in an equivalent circuit illustrated in FIG. 14, the presence or absence of proximity or contact of an external proximity object such as a finger is detected by detecting the amplitude of the detection signal RxAFE output from the detection electrode Rx in a detection circuit 500. Note that a self-detection circuit is not limited to the circuit exemplified in FIG. 14, and any circuit method may be adopted as long as the presence or absence of an external proximity object such as a finger can be detected using only the detection electrode Rx.

According to one embodiment described above, it is possible to provide a display device DSP and a watch 100 provided with the display device DSP, in which an increase in the time required for touch detection can be suppressed even when the number of analog front-end circuits AFE is smaller than the number of detection electrodes Rx.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display area including a display element;
a peripheral area surrounding the display area; and
a plurality of detection electrodes arranged in the peripheral area, wherein
the plurality of detection electrodes are each electrically connected to at least one other detection electrode that is not adjacent thereto.

2. The display device of claim 1, wherein
a first detection electrode, which is one of the plurality of detection electrodes, and a second detection electrode, which is not adjacent to the first detection electrode and electrically connected to the first detection electrode, are connected to a same terminal of an IC chip.

3. The display device of claim 1, wherein
a first detection electrode, which is one of the plurality of detection electrodes, and a second detection electrode, which is not adjacent to the first detection electrode and electrically connected to the first detection electrode, are connected to a same detection circuit.

4. The display device of claim 1, wherein
a first detection electrode, which is one of the plurality of detection electrodes, and a second detection electrode, which is not adjacent to the first detection electrode and electrically connected to the first detection electrode, are arranged at least 9 mm apart.

5. The display device of claim 3, wherein
the plurality of detection electrodes are each adjacent to a detection electrode connected to a different detection circuit, and
a combination of detection circuits to which two adjacent detection electrodes are each connected is different for all of the two adjacent detection electrodes.

6. The display device of claim 3, wherein
the number of detection electrodes is twice or more than the number of detection circuits.

7. The display device of claim 1, wherein
the display device identifies a position of an external proximity object based on a detection signal indicating a largest detection value and a detection signal indicating a second largest detection value among detection signals output from the plurality of detection electrodes respectively.

8. The display device of claim 3, wherein
the display device drives the first detection electrode and the second detection electrode connected to the same detection circuit by a self-capacitance method.

9. The display device of claim 1, further comprising:
a first substrate;
a second substrate facing the first substrate;
a liquid crystal layer arranged between the first substrate and the second substrate; and
a sealant that adheres the first substrate and the second substrate and seals the liquid crystal layer, wherein
the display element includes a pixel electrode and a common electrode.

10. The display device of claim 9, wherein
the pixel electrode is arranged on the first substrate, and
the common electrode is arranged on the second substrate.

11. The display device of claim 9, wherein
the plurality of detection electrodes are arranged on a same layer as the common electrode.

12. The display device of claim 3, wherein
the display device drives a plurality of detection electrodes each connected to a plurality of detection circuits by a self-capacitance method.

13. The display device of claim 12, wherein
the display device drives all detection electrodes each connected to all detection circuits by a self-capacitance method.

14. A watch comprising the display device of claim 1.
